(19) United States
(12) Patent Application Publication
(10) Pub. No.: US 2009/0297760 A1
(43) Pub. Date: Dec. 3, 2009

(54) Method for Surface Coating for Improved Weatherability of Building Products

(75) Inventor: Fredrick Arnoldt, Colleyville, TX (US)

Correspondence Address: WINSTEAD PC, P.O. BOX 50784, DALLAS, TX, 75201, US

(73) Assignee: Q'SO Incorporated, Fort Worth, TX (US)

(21) Appl. No.: 12/473,141

(22) Filed: May 27, 2009

Related U.S. Application Data
(60) Provisional application No. 61/056,700, filed on May 28, 2008.

(51) Int. Cl. B32B 5/12; B05D 1/28; B32B 21/08

(52) U.S. Cl. 428/106; 427/428.01; 428/537.1; 428/512; 428/513; 428/481; 428/413; 428/452

(57) ABSTRACT

The present invention relates to a weatherable building product comprising a wood component. The wood component has at least a portion which is coated with a coating composition comprising a blend of saturated polymers, synthetic resins, plasticizers, and/or filler materials. The wood component comprises solid wood or fiber-based materials.

### CROSS REFERENCES TO RELATED APPLICATIONS

This application claims the benefit of U.S. Provisional Application 61/056,700, filed May 28, 2008.

### FIELD OF INVENTION

The present invention relates to surface coatings, and, more particularly, to surface coating compositions and methods for improving the weatherability of building products.

### BACKGROUND OF THE INVENTION

Different types of sheathing materials are available for various uses, such as the construction of buildings or other structures. Such materials can include Oriented Strand Boards (OSB), plywood, or other particle boards. However, moisture from water can cause various damages to such sheathing materials. Accordingly, many sheathing materials require additional coatings to achieve impermeability to water. Such coatings can include tar paper, felt paper, house-wraps (e.g., thermoplastic polyolefin or TPO), flexible sheets made of waterproofing materials (e.g., polyvinylchloride, polyurethane, and/or polypropylene), or wax-based surface coatings.

However, there are various disadvantages that are associated with the aforementioned coatings. For instance, tar papers may carry excessive weight. Although house-wraps are lighter than tar paper, they may shear after exposure to nails or staples. Furthermore, flexible sheets and wax-based surface coatings may not adhere readily to many surfaces, thereby compromising their moisture-protecting abilities. Additionally, flexible sheets are often thick and cumbersome, making them difficult to install. In addition, many of the available methods require surfaces to be processed extensively before treatment. Therefore, there is currently an unmet need for new surface coating compositions and methods with improved properties.

In the construction of houses and other buildings, it is known to use a variety of types of construction panels for walls, flooring and other surfaces. While it may be preferred to use solid wood boards of hardwood or softwood for such surfaces, solid boards are becoming more and more expensive. An alternative is to use veneer panels for wall surfaces, but as trees of the required type, size and quality become more and more scarce, the manufacture of multilayer veneers or plywoods is becoming both more expensive and veneer panels are more difficult to obtain in a high quality.

It is also known to use gypsum boards or similar panels that are formed from two outer layers of paper material having an inorganic material e.g. gypsum or calcium sulphate, between the layers of paper material. Gypsum board suffers from substantial loss of strength and/or structural integrity if the board becomes wet. Moreover, it is difficult to insert nails, screws or the like into gypsum board to attach decorative articles e.g. paintings, photographs and ornaments, especially if the articles are heavy.

As a result of the need to maintain the costs of construction as reasonable as is practical while still producing buildings of acceptably high quality, efforts have been made to use construction materials that are more economical. For instance, particle board, fibre board, oriented strand board (OSB), hardboard, other similar boards formed from wood that may not otherwise be usable in the construction industry and boards formed from particles, chips, flakes or other fragments of wood, are being used more frequently in the construction of buildings, particularly for wall and floor surfaces and sub-surfaces. Such boards have a quality and integrity that is more than adequate for such use. However, they are often characterized, depending on the particular type and method of construction of the board, by uneven and rough surfaces e.g. OSB has uneven surfaces with indentations that are frequently more than one millimeter in depth. In addition, some such boards also suffer from deficiencies relating to swelling of the boards on exposure to moisture or liquid water; the boards may be coated with wax or otherwise treated in attempts to overcome such a deficiency.

OSB can be manufactured in wide, flat sheets from cross-oriented layers of thin wooden strips compressed and bonded together with wax and resin adhesives. For example, some embodiments may be approximately 95% wood and 5% wax and resin. The sheets of the OSB can be placed in a thermal press to compress the flakes and bond them to the resins by heat activation and curing. OSB panels are often made from aspen or poplar trees without any internal gaps or voids. However, OSB panels still require additional membranes to achieve impermeability to moisture so that they can be adapted for exterior use.

Accordingly, it would be desirable to be able to provide weatherable building products made of wood components which are relatively resistant to damage from exposure to water, moisture, and sunlight. Typically, it is desirable to provide weatherable building products made of wood components which have moisture linear expansions of less than about 0.1%.

Moreover, it would be further desirable to provide weatherable building products made of wood components that will withstand attacks from moisture vapor, direct water, and sunlight and perform well in weatherability tests while remaining readily machined and manipulated by typical household and building trade equipment and which retain paint, primers, and stain finishes in a manner similar to prior art building products as well as meet or exceed the structural properties of currently available building products.

### SUMMARY OF THE INVENTION

The present invention comprises a weatherable building product made of wood components coated with a weatherability coating composition. The present invention also comprises a method for making a weatherable building product comprising coating a wood component with a weatherability coating composition.

The wood component can be made of solid wood or fiber-based materials such as, wood fiber or fibers of agricultural, waste, and recylate byproducts. A final coating of paint, primer, stain or other ultraviolet light-opaque covering may be applied to all surfaces of the weatherable building product.

In certain embodiments, the weatherability coating composition comprises a blend of saturated polymers, synthetic resins, plasticizers, and/or filler materials in various combinations

In other embodiments, surface coating compositions of the invention may be applied to various surfaces, such as Oriented Strand Board (OSB) panels, plywood, particle boards, other construction boards, or other sheathing materials. In further embodiments, the present invention can pertain to methods of obtaining a non-slip surface by adhering a gritty material, such as a particulate, to the surface of a sheathing material with a surface coating composition as set forth herein.

Various embodiments of the present invention can substantially eliminate and/or reduce the disadvantages and problems associated with previous moisture barriers. More specifically, various embodiments of the present invention may address one, some, or all of the above listed disadvantages associated with previous moisture barriers. Therefore, the aspects described herein provide exemplary embodiments and it is noted that there are many and various embodiments that can be incorporated into the spirit and principles of the present invention and the description of the listed embodiments is not to be construed as the only embodiments that incorporate the spirit and principles of the present invention.

### DETAILED DESCRIPTION OF EXEMPLARY EMBODIMENTS

The present invention relates to weatherable building products made of wood components that are resistant to water penetration and degradation due to water, moisture, and sunlight, and to a method of making weatherable building products. Examples of such building products include, but are not limited to, ultra-light-, medium- or high-density fiberboard, oriented strand board, laminated strand lumber, laminated beams, plywood, particle board, and plastic wood. By wood components, it is meant at least one component made from solid wood or fiber-based materials such as, wood fiber or fibers of agricultural, waste, and recylate byproducts.

The wood components made of solid wood can be made of either hardwood or softwood. The wood preferably has a moisture (water) content of less than about 20 weight percent, more preferably about 4-12 weight percent, and most preferably about 6-9 weight percent. The wood is preferably dried in an oven, and more preferably a kiln-type oven to achieve such moisture content. Examples of usable woods include, but are not limited to, Ponderosa pine, oak, maple, ash, poplar, radiata pine, southern yellow pine, and cedar. The wood components can be either unitary wood components of pieced together wood components, such as finger-jointed wood components.

The wood components made of fiber-based materials can be made of wood fiber, wood fiber-wood flour mixtures, fibers of agricultural, waste, and recyclate byproducts, and mixtures thereof. The fiber-based materials are moldable or extrudable under heat and pressure to form building products, such as compression molded door skins or oriented strand board, by methods which are known in the art.

The wood components made of fiber-based materials may also include fillers such as sawdust, mica and wollastonite, excelsior, glass reinforcing fibers, glass fiber reinforcing veil mats, carbon reinforcing fibers, aramid reinforcing fibers, foaming/blowing agents, fungicides, mildewcides, pigments, dyestuffs, fragrances and combinations thereof.

Typically, wood components made from fiber-based materials include a polymeric or resinous binder to adhere the fibers together. The amount and type of binder varies depending on many factors which include, but are not limited to, type of wood component desired, type of fiber employed, type of binder employed, etc. Examples of suitable binders include, but are not limited to, phenol/formaldehyde resol, urea/formaldehyde, melamine/formaldehyde, polyisocyanates, and novolac phenolic (phenol-formaldehyde) resins. The preferred binder is novolac phenolic resin.

In an embodiment of the invention, an OSB construction board is coated with a weatherability surface composition to improve weatherability and durability of the board. In some embodiments, the coating applied to the OSB may include a blend of saturated polymers, synthetic resins, plasticizers, and/or filler materials.

Reference will now be made to the specific components that can be used in the surface coating. However, it will be understood that the invention is not limited to the embodiments disclosed, but is capable of numerous rearrangements, modifications and substitutions without departing from the spirit of the invention as set forth herein.

### Saturated Polymers

In the present invention, saturated polymers generally refer to homo-polymers or hetero-polymers of various compounds that are substantially saturated when they are in polymeric form. One or more saturated polymers can be used in the surface coating compositions of the present invention. Such suitable saturated polymers can be homo-polymers or hetero-polymers of propenes, butenes, isobutenes, styrenes, ethenes, isoprenes, and propenes. For instance, in one example, a surface coating composition can include a poly-isobutylene (e.g., Polyisobutylene TPC 1160 from Texas Petrochemicals), a polypropylene (e.g., Epolene N-15 from Eastman), and/or a hetero-polymer of styrene, ethene and butene (e.g., Calprene H6110 by Dynasol Elastomers). In another example, a saturated polymer can comprise about 98% isobutylene and about 2% isoprene. In another example, a saturated polymer can be a homo-polymer of 2-methyl-1-propene.

Saturated polymers in surface coatings of the present invention can also include polyurethane-type polymers. A polyurethane can be any polymer consisting of a chain of organic units joined by urethane linkages (—RNHCOOR′—). Polyurethane polymers can be formed by reacting a monomer containing at least two isocyanate functional groups (—N═C═O) with another monomer containing at least two alcohol groups (—OH). A general scheme for the production of urethane linkages in a polyurethane is illustrated below as an example:

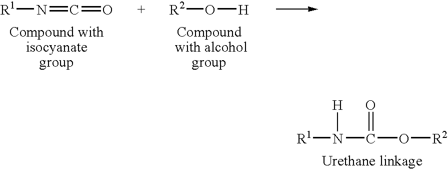

Polyurethane formulations cover an extremely wide range of stiffness, hardness, and densities. Furthermore, such compounds can provide the surface coatings of the present invention with resiliency, flexibility, rigidity, foam-like characteristics, and enhanced adhesive properties.

Saturated polymers can be used at different concentration ranges in the surface coatings of the present invention. Non-limiting examples of such concentration ranges can vary from about 0.01% to about 50%, from about 10% to about 20%, or from about 15% to about 16% by weight of a surface coating composition. In one particular example, a surface coating composition can have about 2.98% Epolene N-15 (Eastman), about 1.91% TPC 1160 (Texas Petrochemicals), and about 11.08% Calprene H6110 (Dynasol Elastomers) to yield a total saturated polymer concentration of about 15.97% by weight of the surface coating composition.

### Synthetic Resins

In the present invention, synthetic resins generally refer to resins with polymeric materials that may be capable of enhancing the adhesive properties of the compositions to which they are added. One or more synthetic resins can be used in the surface coating compositions of the present invention. Non-limiting examples of such resins can include aliphatic resins, aromatic resins, polyester resins, epoxy resins, and/or mixtures thereof.

More specific and non-limiting examples synthetic resins that may be suitable for use in the surface coating compositions of the present invention can include resins that are based on the polymerization of dicyclopentadiene (DCPD) (e.g., Sukorez SU-120 by Kolon Chemical Co.), other C5 compounds (e.g., Super Nevtac 99 by Neville), or propylene (e.g., PP18-S-2 by Huntsman). Other non-limiting examples of synthetic resins can include resins based on the polymerization of vinyltoluenes, indenes, styrenes, or other C9 compounds (e.g., SB-1100 by Sunbelt Chemicals). Another example of a suitable synthetic resin can include a terpene-phenolic resin, such as YS Polyster T115 by Yasuhara Chemical.

Synthetic resins can be used at different concentration ranges in the surface coatings of the present invention. Non-limiting examples of such concentration ranges can vary from about 0.01% to about 50%, from about 25% to about 45%, or from about 35% to about 38% by weight of the surface coating composition. In one particular example, a surface coating composition can have about 0.96% Sukorez SU-120 (Kolon Chemical Co.), about 1.9% Super Nevtac 99 (Neville), about 5.01% PP18-S-2 (Huntsman), about 3.82% YS Polyster T115 (Yasuhara Chemical) and about 25.79% SB-1100 (by Sunbelt Chemicals) to yield a total synthetic resin concentration of about 37.49% by weight of the surface coating composition.

### Plasticizers

As used herein, plasticizers generally refer to compounds that can increase the plasticity or fluidity of the materials to which they are added. Without being bound by theory, it is envisioned that plasticizers can have such effects by embedding themselves between one or more polymeric chains to enhance spacing and free volume.

One or more plasticizers can be used in the surface coating compositions of the present invention. Plasticizers suitable for use in the surface coating compositions of the present invention are well known in the art. Such plasticizes can include without limitation stearic acids (e.g., Industrene B by Sun Oil Co.), naphthenic process oils (e.g., Calsol 5550 by Calumet), plastics, cement, concrete, and clay bodies. More specific examples of plasticizers suitable for use in the present invention can include without limitation dicarboxylic and tricarboxylic ester-based plasticizers, such as (1) phthalate-based plasticizers (e.g., bis(2-ethylhexyl)phthalate, diisononyl phthalate, bis(n-butyl)phthalate, butyl benzyl phthalate, diisodecyl phthalate, di-n-octyl phthalate, diisooctyl phthalate, diethyl phthalate, diisobutyl phthalate, and di-n-hexyl phthalate); (2) trimellitates (e.g., trimethyl trimellitate, tri-(2-ethylhexyl)trimellitate, tri-(n-octyl,n-decyl)trimellitate, tri-(heptyl,nonyl) trimellitate, and n-octyl trimellitate); (3) adipate-based plasticizers (e.g., bis(2-ethylhexyl)adipate, dimethyl adipate, monomethyl adipate, and dioctyl adipate); (4) sebacate-based plasticiser (e.g., dibutyl sebacate); and (5) maleates (e.g., dibutyl maleate, and diisobutyl maleate). Other plasticizers suitable for use in the surface coatings of the present invention can include benzoates, epoxidized vegetable oils, sulfonamides, N-ethyl toluene sulfonamide, N-(2-hydroxypropyl)benzene sulfonamide, N-(n-butyl)benzene sulfonamide, organophosphates, tricresyl phosphate, tributyl phosphate, glycols, polyethers, triethylene glycol dihexanoate, tetraethylene glycol diheptanoate, and other polymeric plasticizers.

In an alternative embodiment of the present invention, it may be desirable to use plasticizers that are environmentally friendly, particularly plasticizers with better biodegradability and less biochemical effects. Non-limiting examples of such plasticizers can include acetylated monoglycerides, alkyl citrates (e.g., triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate), and alkyl sulphonic acid phenyl esters.

Plasticizers can be used at different concentration ranges in the surface coatings of the present invention. Non-limiting examples of such concentration ranges can vary from about 0.01% to about 50%, from about 29% to about 34%, or from about 32% to about 33% by weight of the surface coating composition. In one particular example, a surface coating composition can have about 1.91% of Industrene B (Sun Oil Co.) and about 30.57% of Calsol 5550 (Calumet) to yield a total plasticizer concentration of about 32.48% by weight of the surface coating composition.

### Filler Materials

As used herein, filler materials generally refer to compounds that can enhance one or more properties of the compositions to which they are added. Such enhanced properties can include without limitation improved processing, improved density control, enhanced optical effects, better conductivity, improved expansion, better electrical properties, enhanced magnetic properties, improved flame retardancy, and improved mechanical properties (e.g., elasticity).

One or more fillers can be used in the surface coating compositions of the present invention. Such fillers can include without limitation oxidic fillers, silicatic fillers, water-soluble salts of metals, and organosilane compounds. More specific and non-limiting examples of fillers suitable for use in the surface coatings of the present invention can include anti-oxidants (e.g., Bennox 1010 by Mayzo), fumed silica (e.g., Orisil 200 by Orisil), calcium carbonate (e.g., Hubercarb W3 by Akrochem), metakaolinite, alumina trihydrate, carbon blacks, kaolin clays, aluminium oxide, aluminium hydroxide, aluminium trihydrate, and titanium dioxide.

Filler materials can be used at different concentration ranges in the surface coatings of the present invention. Non-limiting examples of such concentration ranges can vary from about 0.01% to about 50%, from about 10% to about 16%, or from about 14% to about 15% by weight of the surface coating composition. In one particular example, a surface coating composition can have about 0.31% of Bennox 1010 (Mayzo), about 0.38% of Orisil 200 (Orisil), and about 13.37% of Hubercarb W3 (Akrochem) to yield a total filler concentration of about 14.06% by weight of the surface coating composition.

### Preparation and Application

In preparing the surface coating compositions of the present invention, the individual components can be mixed by conventional methods in various sequences. For instance, the surface compositions may be prepared by mill-mixing or internal mixing. In addition, surface coating compositions of the present invention can be adapted to be melt-applied and/or heat-sealed to surfaces by various melt-coating processes.

The surface coating compositions of the present invention can also be applied to various surfaces. In an embodiment, a surface coating composition can be applied to an OSB panel. In other examples, surface coating compositions can be applied to plywood, particle boards, other wood boards that can be used in sheathing a building, or other sheathing materials.

In other embodiments, the surface coating compositions of the present invention can stably adhere to the coated surfaces, such as the wood fibers of a construction board. Such a property can be particularly advantageous when the coated surface requires additional modifications and/or treatments. For instance, when construction boards are manufactured, a paraffin or wax film is applied to give the surface of the boards a slight hydrophobic coating. A problem that this thin paraffin film may cause is that traditional surface coatings may not readily adhere to the wood fibers, but rather adhere to the thin paraffin film. This can be disadvantageous because if a seal tape is applied to seal the seams in between the construction boards, the tape may not be readily removed without also removing the surface coating. However, various embodiments of the compositions of the present invention can be adapted to overcome this disadvantage by going through the paraffin film and adhering directly to the wood fibers of the construction board. As a result, any adhesive tape applied to seal the seams, joints, and/or gaps in between the construction boards can be removed without removing the surface coating.

In a further embodiment of the present invention, an aggregate, such as a gritty and/or particulate material, may also be applied to a surface after the application of a surface coating. In one example, the application of the aggregate material can occur after a surface coating has been applied but before it has completely cooled. During this interim stage, the surface coating may be in a substantially warm and tacky state such that it can adhere to the aggregate materials in a substantially uniform manner. In another example, an aggregate may be applied to a coated surface after the surface coating is reheated to an elevated temperature (e.g., greater than 250° F.).

The addition of aggregates to a coated surface can make the surface ragged. Advantageously, such a surface may become skid-resistant, thereby providing a safer working environment. This can be particularly desirable when a treated surface is a pitched roof or another surface that may require human accessibility.

The applied surface coating compositions of the present invention can have various advantageous properties. For instance, the surface coating compositions of the present invention can be formulated such that the need for a carrier vehicle, such as a solvent and/or water, is substantially eliminated. In further embodiments, the surface coating compositions may be formulated such that the need for external curing forces and/or catalysts, such as, for example, heat, RF, and/or UV, are substantially eliminated. In other embodiments, the surface coating may be formulated as a ready-to-use mixture, thereby substantially eliminating the need for a multi-component mixture that may require an off-site treatment facility.

Advantageously, surface coating compositions of the present invention can also be flexible and durable. The surface coating compositions can also have waterproof properties for at least one side of a surface. In addition, the surface coating compositions may provide UV protection. Likewise, the surface coating compositions may be high rheology, meltable compound that perform similarly to chemically-cured rubber without the need for a vulcanization step. Furthermore, the surface coating compositions may reduce and/or eliminate the need for job-site applied products, such as job-site applied liquid sprays and/or house-wraps.

### WORKING EXAMPLES

The invention will now be described more fully with reference to specific examples, which are intended as being illustrative only rather than as limiting the invention.

### Example 1

### Preparation of a Surface Coating Mixture

Bennox 1010 (anti-oxidant by Mayzo) and PP18-S-2 (polypropylene resin by Huntsman) were added to a heated mixer along with Calsol 5550 (Naphthenic process oil by Calumet). Once the temperature of the mixture reached 300 F, Calprene 6110 (elastomeric polymer by Dynasol Elastomers) was added. Next, the mixer was actuated while heating continued. After the mixture temperature reached 370 F, SB-100 (C9 hydrocarbon resin by Sunbelt) was added. Thereafter, mixing continued until the temperature of the mixture reached 400 F. Next, the mixture temperature was reduced to 350 F while agitation continued. Hubercarb W3 (calcium carbonate by Akrochem) and Orisil 200 (fumed silica by Orisil) were then added to the mixture. Mixing continued until a uniform mixture was obtained. Thereafter, the adhesion resins Sukorez SU-120 (Kolon Chemical Co.), Polyster T-115 (Yasuhara Chemical), and Super Nevtac 99 (Neville) were added to the mixture. After a uniform mixture was obtained, Industrene B (stearic acid by Sun Oil Co), Epolene N-15 (polypropylene wax by Eastman) and TPC 1160 (saturated polymer by Texas Petrochemicals) were added. Agitation continued until a uniform mixture was obtained. Thereafter, the agitation rate was reduced, and a sample was obtained for quality control testing. The mixture was then divided into 1000 ml aliquots and stored in boxes containers at ambient temperature.

The table below lists each of the ingredients in the surface coating mixture of this example:

TABLE 1

| Ingredient/ | | | Concentration | |
|---|---|---|---|---|
| Trade Name | Description | Category | (% by weight) | Parts |
| TPC 1160 | Polybutene | Saturated Polymer | 1.91 | 50 |
| Calsol 5550 | Napthenic oil | Plasticizer/Filler Material | 30.57 | 800 |
| Sukorez SU-120 | Hydrocarbon resin | Synthetic Resin | 0.96 | 25 |
| Epolene N-15 | Polypropylene wax | Saturated Polymer | 2.98 | 78 |
| Bennox 1010 | Antioxidant | Filler Material | 0.31 | 8 |
| SB-1100 | C9 hydrocarbon resin | Synthetic Resin | 25.79 | 675 |
| Orisil 200 | Fumed silica | Filler Material | 0.38 | 10 |
| Hubercarb W3 | Calcium carbonate | Filler Material | 13.37 | 350 |
| Polyster T-115 | Terpene phenolic resin | Synthetic Resin | 3.82 | 100 |
| Industrene B | Stearic acid | Plasticizer | 1.91 | 50 |
| Huntsman PP18-S-2 | Polypropylene resin | Synthetic Resin | 5.01 | 131 |
| Super Nevtac 99 | Aliphatic hydrocarbon | Synthetic Resin | 1.91 | 50 |
| | resin | | | |
| Calprene 6110 | Block polymer | Saturated Polymer | 11.08 | 290 |

### Example 2

### Quality Control on the Surface Coating Mixture of Example 1

Sample for batch is taken and its viscosity characteristics are determined by a rheometer normally set at 350 F. Different temperatures may be used depending upon eventual customer needs. A Ball and Ring softening point is prepared from a molten sample. Product hardness can then be measured on a cooled sample via a Shore Hardness Gage. For product identification, an IR Scan is taken and compared to a standard scan. If required, special properties such as flame retardancy can also be tested.

### Example 3

### Application of the Surface Coating Mixture of Example 1 to an OSB

The coating material is supplied as a solid in drums, pails or 5# blocks. This product is then put into a molten state and fed into the bank of a roll coater, slot die coater, knife over roll coater, hot melt gravure coater or other similar melt applicator. The sheets of OSB are then passed under the coating head and the desired application coat weight of compound is applied to the board. This coating can be applied either in line or as an adjunct process depending upon market requirements.

Although various embodiments of the methods and systems of the present invention have been described in the foregoing Description, it will be understood that the invention is not limited to the embodiments disclosed, but is capable of numerous rearrangements, modifications and substitutions without departing from the spirit of the invention as set forth herein.

What is claimed is:

1. A method for making a weatherable building product comprising:
coating at least a portion of a wood component with a surface coating composition comprising one or more saturated polymers, one or more synthetic resins, and one or more plasticizers.

2. The method according to claim 1 wherein the surface coating composition further comprises one or more filler materials.

3. The method of claim 1 wherein the one or more saturated polymers are homopolymers of propenes, butenes, isobutenes, styrenes, ethenes, isoprenes and propenes.

4. The method of claim 1 wherein the one or more saturated polymers are heteropolymers of propenes, butenes, isobutenes, styrenes, ethenes, isoprenes and propenes.

5. The method of claim 1 wherein the one or more saturated polymers range from about 0.01% to about 50% by weight of the surface coating composition.

6. The method of claim 1 wherein the one or more synthetic resins are aliphatic resins, aromatic resins, polyester resins, epoxy resins and mixtures thereof.

7. The method of claim 1 wherein the one or more synthetic resins range from about 0.01% to about 50% by weight of the surface coating composition.

8. The method of claim 1 wherein the one or more plasticizers are stearic acids and naphthenic oils.

9. The method of claim 1 wherein the one or more plasticizers range from about 0.01% to about 50% by weight of the surface coating composition.

10. The method of claim 2 wherein the one or more filler materials are oxidic fillers, silicatic fillers, water-soluble metal salts, organosilane compounds, fumed silica and antioxidants.

11. The method of claim 2 wherein the one or more filler materials range from about 0.01% to about 50% by weight of the surface coating composition.

12. The method of claim 1 wherein the wood component comprises solid wood or fiber-based materials.

13. The method of claim 12 wherein the wood component is made of fiber, wax and resin.

14. The method of claim 13 wherein the wood component is an oriented strand board (OSB).

15. A weatherable building product comprising:
a wood component;
at least a portion of the wood component being coated with a surface coating composition comprising one or more saturated polymers, one or more synthetic resins, and one or more plasticizers.

16. The building product according to claim 15 wherein the surface coating composition further comprises one or more filler materials.

17. The building product of claim 15 wherein the one or more saturated polymers are homopolymers of propenes, butenes, isobutenes, styrenes, ethenes, isoprenes and propenes.

18. The building product of claim 15 wherein the one or more saturated polymers are heteropolymers of propenes, butenes, isobutenes, styrenes, ethenes, isoprenes and propenes.

19. The building product of claim 15 wherein the one or more saturated polymers range from about 0.01% to about 50% by weight of the surface coating composition.

20. The building product of claim 15 wherein the one or more synthetic resins are aliphatic resins, aromatic resins, polyester resins, epoxy resins and mixtures thereof.

21. The building product of claim 15 wherein the one or more synthetic resins range from about 0.01% to about 50% by weight of the surface coating composition.

22. The building product of claim 15 wherein the one or more plasticizers are stearic acids and naphthenic oils.

23. The building product of claim 15 wherein the one or more plasticizers range from about 0.01% to about 50% by weight of the surface coating composition.

24. The building product of claim 16 wherein the one or more filler materials are oxidic fillers, silicatic fillers, water-soluble metal salts, organosilane compounds, fumed silica and antioxidants.

25. The building product of claim 16 wherein the one or more filler materials range from about 0.01% to about 50% by weight of the surface coating composition.

26. The building product of claim 15 wherein the wood component comprises solid wood or fiber-based materials.

27. The building product of claim 15 wherein the wood component is made of fiber, wax and resin.

28. The building product of claim 27 wherein the wood component is an oriented strand board (OSB).
